(19) United States
(12) Patent Application Publication
(10) Pub. No.: US 2011/0246578 A1
(43) Pub. Date: Oct. 6, 2011

(54) Method and system for analyzing messages

(75) Inventors: Matthias Leo Jugel, Berlin (DE); Mikio Braun, Berlin (DE); Klaus-Robert Müller, Berlin (DE)

(73) Assignee: Technische Universitat Berlin

(21) Appl. No.: 12/662,145

(22) Filed: Mar. 31, 2010

(51) Int. Cl. G06F 15/16

(52) U.S. Cl. 709/206

(57) ABSTRACT

The invention relates to a method and system for analyzing messages transmitted in a communication network. An embodiment of the method comprises the steps of: determining an information-related citation index indicating how often information comprised in a message has been forwarded in consecutive messages to other users of the communication network, and providing an analysis result based on the information-related citation index.

### BACKGROUND OF THE INVENTION

The invention relates to a method and system for analyzing messages transmitted in a communication network.

Current instances of communication networks are for example internet platforms like twitter (http://twitter.com), or facebook (http://facebook.com). On these sites, up to several hundred million users communicate through the exchange of status messages and direct messages.

A highly relevant problem in the analysis of such communication networks is the assessment of the influence of a user, and to extract emerging trends out of the whole body of ongoing communication and make them available for further use.

### OBJECTIVE OF THE PRESENT INVENTION

Accordingly, the objective of the present invention is to provide a method and system for analyzing a communication network in order to determine the influence of users of the communication network.

Another objective of the present invention is to provide a method and system for analyzing a communication network in order to extract trends in ongoing communication.

### BRIEF SUMMARY OF THE INVENTION

An embodiment of the invention relates to a method for analyzing messages transmitted in a communication network wherein an information-related citation index is determined. Said information-related citation index indicates how often information comprised in a message has been forwarded in consecutive messages to other users of the communication network. Then, the information-related citation index may be analyzed in order to determine the influence of users and/or to extract trends.

The information may be considered to be forwarded if the respective message containing said information has been forwarded unchanged. However, according to a preferred embodiment of the invention, a text analysis is carried out in order to identify a predefined information and in order to determine whether the predefined information has been forwarded or not. A text analysis allows identifying information in messages even if the message has been altered. In other words, the step of determining the impact of a particular user preferably includes at least one bibliometric procedure being based on a citation analysis and a content analysis of transmitted information.

Furthermore, by evaluating the information-related citation index of information sent by a particular user, an impact value indicating the impact of said particular user on the communication network may be determined. Preferably, the evaluation of information is weighted taking the information's age into account. E.g., recent information is assigned a larger weight than older information. Alternatively, only recent information may be evaluated, and older information may be discarded. For instance, information may be considered “recent”, if it is younger than a predefined age. According to a preferred embodiment the bibliometric procedure includes a Hirsch-analysis, e.g. the information-related citation index may be Hirsch-index.

Another preferred embodiment comprises the steps of: analyzing a plurality of messages sent by said particular user, determining the information-related citation index of each information contained in said plurality of messages, determining an aggregating information-related statistics measuring the spread of the citation histogram, and determining the user's impact value based on said weighted average information-related citation index value.

The method as described above may be used to provide lists indicating users according to their impact on the communication network. To this end, an embodiment of the invention also allows for inputting a search query concerning user impact, and outputting users and/or their impact values in a ranked list, wherein the ranking corresponds to the users' impact values.

Another preferred embodiment of the invention relates to a method for determining a relevance value for messages. For instance, the method may comprise the step of determining the information-related citation index of information comprised in a particular message. This allows determining a relevance value which indicates the relevance of said particular message.

The relevance value may also consider the age of each message. Preferably younger messages are considered more relevant for the communication network than older messages.

The step of determining the relevance of a particular message may also include searching for one or more keywords in said particular message and determining a match factor indicating to what extend those keywords exist in said message. The calculation of the relevance value may include this match factor.

The relevance value of messages may also take the impact value of the sending user into account. According to this embodiment relevance values of messages are linked with the impact value of the sending users.

The method may also be used to provide message lists which indicate the impact of messages on the communication network. Thus, an embodiment of the invention may include the steps of inputting a search query concerning message relevance, and outputting messages and/or their relevance values in a ranked list, wherein the ranking corresponds to the messages' relevance values.

In order to determine relevant messages concerning a particular topic, an embodiment of the invention provides for inputting a search query identifying one or more keywords, and outputting all messages comprising at least one of those keywords, in a ranked list, wherein the ranking reflects the messages' relevance values.

Another embodiment of the invention allows generating a user specific data set characterizing topics preferred by the corresponding user. To this end, the method may comprise the steps of identifying characteristic words contained in information sent by the user. Then a weight factor may be assigned for each characteristic word, wherein the weight factor indicates the occurrence of the characteristic words in the information sent by the user. The weight factor may also be weighted for each characteristic word with the information-related citation index corresponding to the information which contains the respective word.

The method as described above may be used to provide a search tool for user specific data sets. To this end, an embodiment of the invention may also include the steps of inputting a search query concerning a user specific data set, and outputting the user specific data set as a search result.

Furthermore, the method may be directed to evaluate neighborhood relations between users. For example, user specific data sets may be generated for different users, and the user specific data sets may be compared. This allows calculating a neighborhood value indicating the similarity of communicated topics by said different users.

In order to identify neighborhood relations in a listed form, the method may comprise the steps of inputting a search query concerning neighborhood relations with respect to a particular user, and outputting neighbors in a ranked list, wherein the ranking corresponds to the neighborhood values.

Additionally or alternatively, the method may comprise the steps of inputting a search query identifying one or more keywords, and outputting neighbors in a ranked list, wherein the ranking reflects the match between said keywords and the topics listed in the user specific data sets.

Additionally, the method may comprise the steps of inputting a search query concerning communicated topics, and outputting neighbors and/or neighborhood values indicating the similarity of communicated topics.

The invention also relates to a system for analyzing messages transmitted in a communication network. An embodiment of the invention may comprise means for determining an information-related citation index indicating how often an information comprised in a message has been forwarded in consecutive messages to other users of the communication network, and means for storing information-related citation indices.

### BRIEF DESCRIPTION OF THE DRAWINGS

In order that the manner in which the above-recited and other advantages of the invention are obtained will be readily understood, a more particular description of the invention briefly described above will be rendered by reference to specific embodiments thereof which are illustrated in the appended drawings. Understanding that these drawings depict only typical embodiments of the invention and are therefore not to be considered to be limiting of its scope, the invention will be described and explained with additional specificity and detail by the use of the accompanying drawings in which

FIG. 1 shows an exemplary embodiment of an inventive system;

FIG. 2 shows an exemplary embodiment of a process flow which may be carried out by the system shown in FIG. 1; and

FIG. 3 shows in an exemplary fashion an embodiment of a trend analysis, wherein the citation activity related to individual messages is analyzed over a time window.

### DETAILED DESCRIPTION OF THE PREFERRED EMBODIMENT

The preferred embodiment of the present invention will be best understood by reference to the drawings, wherein identical or comparable parts are designated by the same reference signs throughout.

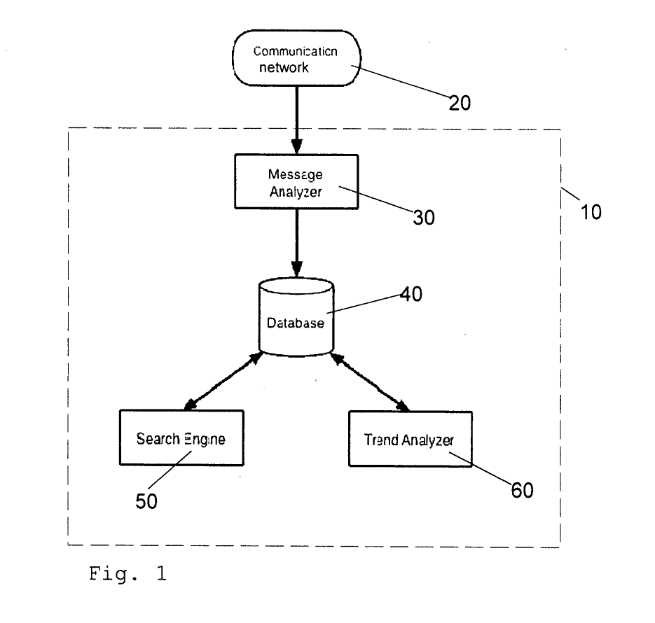

It will be readily understood that the process steps of the present invention, as generally described and illustrated in the figures herein, could vary in a wide range of different process steps. Thus, the following more detailed description of the exemplary embodiments of the present invention, as represented in FIGS. 1-3 is not intended to limit the scope of the invention, as claimed, but is merely representative of presently preferred embodiments of the invention.

FIG. 1 shows an exemplary embodiment of a system 10 for analyzing messages transmitted in a communication network 20.

System 10 comprises a message analyzer 30 which intercepts messages transmitted over the communication network 20. Message analyzer 30 analyzes the messages and extracts information. The extraction of information may be carried out by subjecting the messages to a text analysis or other prior art bibliometric procedures.

For identified information, message analyzer 30 determines an information-related citation index which indicates how often the respective information comprised in a first message has been forwarded in consecutive messages to other users of the communication network. The information-related citation indices are stored in database 40.

System 10 further comprises a search engine 50 and a trend analyzer 60. Search engine 50 allows a person, who is supervising the communication network 20, to enter search questions in order to extract data concerning

(a) the impact of users on communication network 20,

(b) the relevance of messages in communication network 20 and/or

(c) neighborhood relations between users.

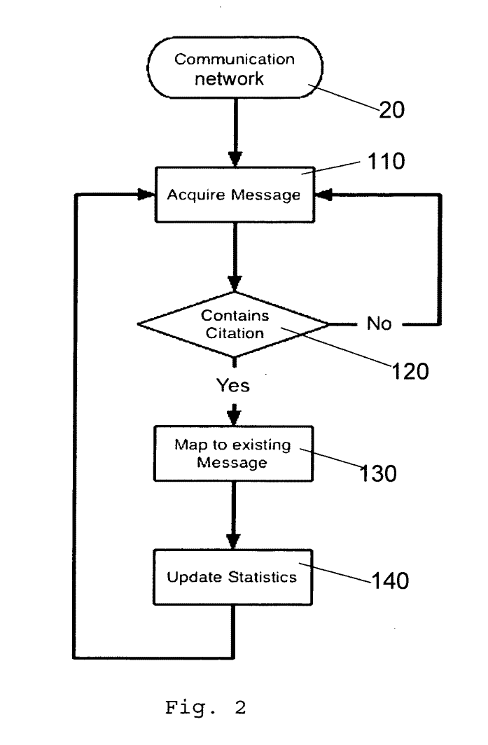

FIG. 2 shows in an exemplary fashion how system 10 may run. In step 110, the message analyzer 30 intercepts the communication network 20 and acquires messages. The message analyzer analyzes the messages and identifies cited information (step 120). If cited information is found, the information is mapped to existing prior messages containing the same information and a citation index is calculated (step 130). Then, in step 140, database 40 is updated. This allows a person who is supervising communication network 20, to extract updated data related to the impact of users on communication network 20, the relevance of messages in communication network 20 and/or neighborhood relations between users.

The exemplary embodiment as described above allows the sustained, exact definition and measurement of the impact of users in communication network 20, for example, the communication hierarchies in companies, or in the armed forces, online communication, for example instant messaging (chat), email, blogs, or social networks, for example facebook and twitter. The exemplary embodiment as described above may also use the actual communication patterns between users, where electronically available, as the basis for impact measurement and further analyses using bibliographic measures. The actual communication may then be analyzed in real-time based on impact estimation in order to detect current trends (that is, dominating topics) within communication network 20, to enable search queries and topic-related navigation, and to improve the search results of existing methods.

The exemplary embodiment as described above is preferably connected through appropriate interfaces to historical or real-time communication data. Communication patterns where one user refers to the messages of another user may then be extracted.

The extracted information may be stored in database 40 and linked to the sending users: the user who created the message, and the user who created the original message. The cited information may be mapped to already identified information. Here, the use of text analysis is advantageous, because messages can also occur in slightly edited or commented forms.

In this way, system 10 may obtain a temporally changing network of interaction between users, which may be the basis for further analysis.

The impact of a user may be computed by analyzing how often each of his messages are cited or commented. The impact may be computed using a bibliometric procedure, for example the so-called Hirsch-index (J. E. Hirsch “An index to quantify an individual's scientific research output”, PNAS Nov. 15, 2005 vol. 102 no. 46 16569-16572).

The analysis as discussed above primarily considers actual interactions and not only the static linkage structure of users. The static linkage structure of users may already be outdated, for example, because users have ceased to participate in the network without deleting their accounts.

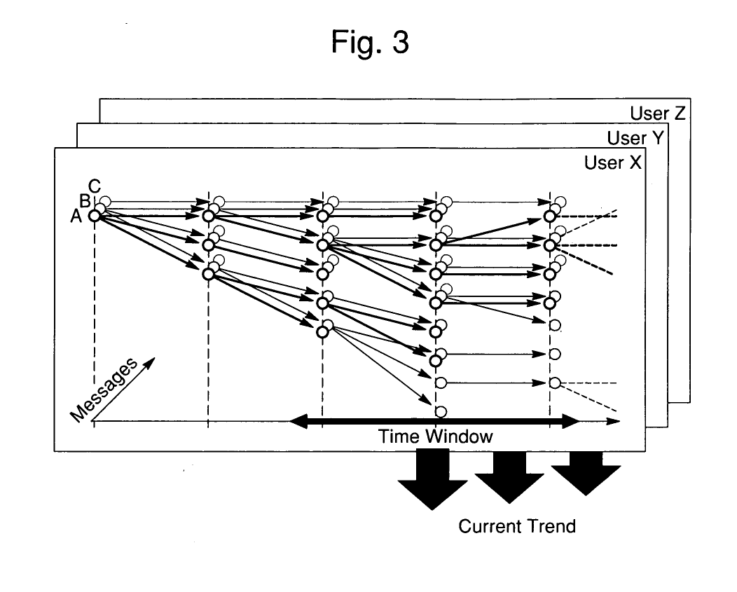

For the trend analysis, the citation activity related to individual messages is preferably analyzed over a time window (see FIG. 3).

Based on impact factors, both for single users but also for single messages, the ranking of results of search queries for certain keywords by relevance can be significantly improved. For example, the number of citations of a message allows to directly derive the relevance of a message, in contrast to existing approaches which only use how recent a message is and whether it contains the keywords.

For improving the search results, a text index may be stored in database 40, which allows to efficiently searching for messages containing certain key words. The results of the initial search query may be ranked based on an adjustable mixture of recency and citation frequency. In order to bring these quantities on the same scale, the age of a message may be rescaled such that the most recent messages have score 1 and infinitely old messages have score 0, with an adjustable decay rate. The citation count is also normalized to the interval 0 to 1 over all found results.

Further, two impact measures may also be used to provide content based neighborhood analysis. E.g., such an analysis may be used to find other users which are communicating over similar topics. Using the impact measures as a weighting, a much more accurate representation of the topics of a user can be estimated because the weighting ensures that only messages which other users found relevant is used to form the topic representation of a user. First, word frequencies may be computed over the whole message corpus. Then, individual weights for single words may be computed, for example based on the term-frequency/inverse-document-frequency measure (tf-idf) (Spärck Jones, Karen, “A statistical interpretation of term specificity and its application in retrieval”, Journal of Documentation 28 (1): 11-21, 1972). Terms which lie below a certain threshold (and therefore occur in almost all messages) may be removed. Moreover, the weights may be scaled using the citation count of messages normalized by user. The weights can then be used for further similarity search, for example based on scalar products or related measures.

1. Method for analyzing messages transmitted in a communication network, the method comprising the steps of:
determining an information-related citation index indicating how often an information comprised in a message has been forwarded in consecutive messages to other users of the communication network, and
providing an analysis result based on the information-related citation index.

2. Method of claim 1, wherein the information is considered to be forwarded if the respective message containing said information has been forwarded unchanged.

3. Method of claim 1, wherein messages are subjected to a text analysis in order to determine whether they include a specific information.

4. Method of claim 1, further comprising the step of: determining an impact value indicating the impact of a particular user on said communication network by evaluating the information-related citation index of at least one information sent by said particular user.

5. Method of claim 1, further comprising the step of: determining an impact value indicating the impact of a particular user on said communication network by evaluating the information-related citation index of recent information sent by said particular user, wherein information is considered recent, if it is younger than a predefined age.

6. Method of claim 4, wherein the step of determining the impact of the particular user includes a bibliometric procedure.

7. Method of claim 6, wherein said bibliometric procedure is a Hirsch-analysis and the information-related citation index is a Hirsch-index.

8. Method of claim 4, further comprising the steps of:
analyzing a plurality of messages sent by said particular user,
determining the information-related citation index of each information contained in said plurality of messages,
determining an aggregating information-related statistics measuring the spread of the citation histogram, and
determining the user's impact value based on said weighted average information-related citation index value.

9. Method of claim 4, further comprising the steps of:
inputting a search query concerning user impact, and
outputting users and/or their impact values in a ranked list, wherein the ranking corresponds to the users' impact values.

10. Method of claim 1, further comprising the steps of:
determining the information-related citation index of information comprised in a particular message, and
determining a relevance value indicating the relevance of said particular message based on the determined information-related citation index of the information comprised therein.

11. Method of claim 10, further comprising the steps of:
determining the age of said particular message, and
determining said relevance value further based on the age of said particular message.

12. Method of claim 10, further comprising the steps of:
searching for one or more keywords in said particular message and determining a match factor indicating to what extend those keywords exist in said message, and
determining said relevance value further based on said match factor.

13. Method of claim 10, further comprising the steps of:
inputting a search query concerning message relevance, and
outputting messages and/or their relevance values in a ranked list, wherein the ranking corresponds to the messages' relevance values.

14. Method of claim 1, wherein at least one user specific data set characterizing topics preferred by the at least one user, is generated, the method comprising the steps of:
identifying characteristic words contained in information sent by the at least one user,
assigning a weight factor for each characteristic word, said weight factor indicating the occurrence of the characteristic word in the information sent by the at least one user, and
weighting said weight factor for each characteristic word with the information-related citation index corresponding to the information which contains the respective word.

15. Method of claim 14, further comprising the steps of:
inputting a search query concerning at least one user specific data set, and
outputting the at least one user specific data set as a search result.

16. Method of claim 14, further comprising the steps of:
generating user specific data sets for at least two different users,
comparing said user specific data sets, and
generating a neighborhood value indicating the similarity of communicated topics by said at least two different users.

17. Method of claim 16, further comprising the steps of:
inputting a search query concerning neighborhood relations with respect to a particular user, and
outputting neighbors in a ranked list, wherein the ranking corresponds to the neighborhood values.

18. Method of claim 16, further comprising the steps of:
inputting a search query concerning communicated topics, and
outputting neighbors and/or neighborhood values indicating the similarity of communicated topics.

19. System for analyzing messages transmitted in a communication network, the system comprising:
means for determining an information-related citation index indicating how often an information comprised in a message has been forwarded in consecutive messages to other users of the communication network, and
means for storing information-related citation indices.
